(19) United States
(12) Patent Application Publication
(10) Pub. No.: US 2012/0078142 A1
(43) Pub. Date: Mar. 29, 2012

(54) CONTINUOUS PASSIVE MOTION DEVICE

(76) Inventor: Randall Fenkell, West Bloomfield, MI (US)

(21) Appl. No.: 13/071,591

(22) Filed: Mar. 25, 2011

Related U.S. Application Data
(60) Provisional application No. 61/317,420, filed on Mar. 25, 2010.

(51) Int. Cl. A61H 1/02

(52) U.S. Cl. 601/5

(57) ABSTRACT

A CPM chair for repeatedly flexing and extending a patient's knee permits a patient to remain comfortably seated while controlling therapeutic knee flexure and extension. A slide member is longitudinally reciprocal between extended and retracted positions with its slide direction controlled by the patent. A drum has an endless cable wrapped about its periphery and is rotated in alternate directions by a reversible electrical motor. The cable extends over respective forward and rearward pulleys and is secured to the slide member. A pedal assembly supports the patient's foot and is pivotally secured to the slide member to accommodate different positions of the patient's heel. Control switches are actuable by the patient to control slide member direction.

### CROSS REFERENCE TO RELATED APPLICATIONS

The present application is a Nonprovisional Application of Provisional Application No. 61/317,420, filed 25 Mar. 2010 and entitled “Continuous Passive Motion Systems,” the disclosure of which are hereby incorporated by reference in its entirety.

### FIELD OF THE INVENTION

present invention pertains generally to continuous passive motion (CPM) device and, more particularly, to a physical therapy chair for imparting flexure to the knee of patient recovering from an injury or knee replacement surgery.

### BACKGROUND OF THE INVENTION

Injury to or surgical procedures on limbs and joints are typically followed by a period of rehabilitation in order to aid recovery. Such postoperative rehabilitation of the joint has been shown to reduce the likelihood of ligamentous and articular adhesions, thromboembolism, venos stasis, post-traumatic osteopenia, peripheral edema, and muscle atrophy. Joint rehabilitation further promotes faster healing, reduction of the amount of pain experienced, and improvement in the range of motion of the affected. Such rehabilitation generally requires that the knee be flexed and the leg be extended such as occurs in normal walking; however, it is frequently undesirable for a recovering patient to bear weight on his leg while rehabilitating his knee. In addition, when a knee has suffered a trauma or other injury, or after surgery, a person often lacks the necessary muscle control, strength, or will to flex his knee and straighten his leg. The therapeutic use of an external force to flex and extend the limb to induce motion is referred to as passive motion. Continuous passive motion (CPM) devices are typically motor driven device designed to exercise a particular joint by repeatedly extending and flexing the joint. CPM devices are capable of applying continuous motion to the joint in a repeatable, consistent manner.

Conventional CPM devices for knees are generally closed systems requiring the limb to be enclosed within femoral and/or tibial supports. This is often uncomfortable for the user, since the leg is fixed along a longitudinal path that may not represent the natural flexing motion of the user's leg. In addition, many knee CPM devices require the user to be oriented in the supine position for its use. This is problematic, particularly for the elderly or users with back conditions.

Consequently, there is a need for a rehabilitation device that can be used to mobilize the joint over a period of time as a part of the orthopedic care. There further remains a need for CPM devices that are simpler in construction, are easier for a patient to use, and enable a user to receive treatment while seated.

### SUMMARY OF THE INVENTION

The present invention is directed toward a continuous passive motion (CPM) device operable to repeatedly flex and extend a joint (e.g., a knee) along predetermined pathway. The CPM device includes a user support, a CPM assembly, and a control unit. The user support orients a user in a non-supine (e.g., seated) position. The CPM assembly includes a carriage with a foot support that receives and supports the foot of a user. The carriage is configured to move in a reciprocal motion, traveling along a generally linear travel path. The control unit controls one or more operational parameters of the device. In operation, a user is seated on the user support, placing a foot within the foot support. The CPM device is activated (via the controller) and the carriage reciprocally travels along its travel path, extending outward from and retracting inward toward the user support, bending the knee of the user and providing rehabilitative treatment to the joint.

### BRIEF DESCRIPTION OF THE DRAWINGS

FIG. 1A illustrates perspective view of a continuous passive motion device in accordance with an embodiment of the invention.

FIG. 1B illustrates a perspective view of the continuous passive motion device shown in FIG. 1A.

FIG. 1C illustrates is a side plan view of the continuous passive motion device shown in FIG. 1A.

FIG. 2 illustrates an isolated plan view of the continuous passive motion assembly shown in FIG. 1A, with the cover removed for clarity.

FIG. 3 illustrates the foot support assembly of the continuous passive motion assembly in accordance with an embodiment of the invention.

FIG. 4A illustrates a partial cross sectional view of the continuous passive motion assembly shown in FIG. 2, showing the drive assembly.

FIG. 4B illustrates a partial cross sectional view of the continuous passive motion assembly shown in FIG. 2, showing a close-up of the limit switch.

FIG. 4C illustrates a rear perspective view of the continuous passive motion assembly shown in FIG. 2.

FIG. 5 illustrates an exploded view of the continuous passive motion assembly shown in FIG. 2, showing the guide rail system of the device.

FIG. 6 is a schematic of the electronic components of the continuous passive motion device.

FIGS. 7A and 7B show the operation of the device, with the carriage moving from its extended position (FIG. 7A) to its retracted position (FIG. 7B)

Like reference numerals have been used to identify like elements throughout this disclosure.

### DETAILED DESCRIPTION OF THE INVENTION

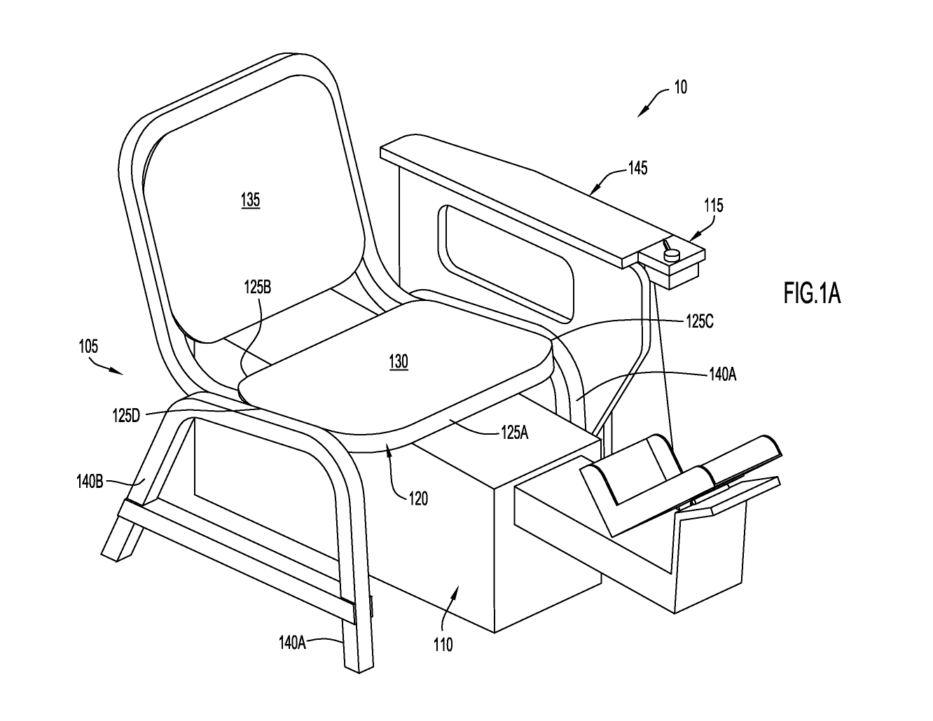

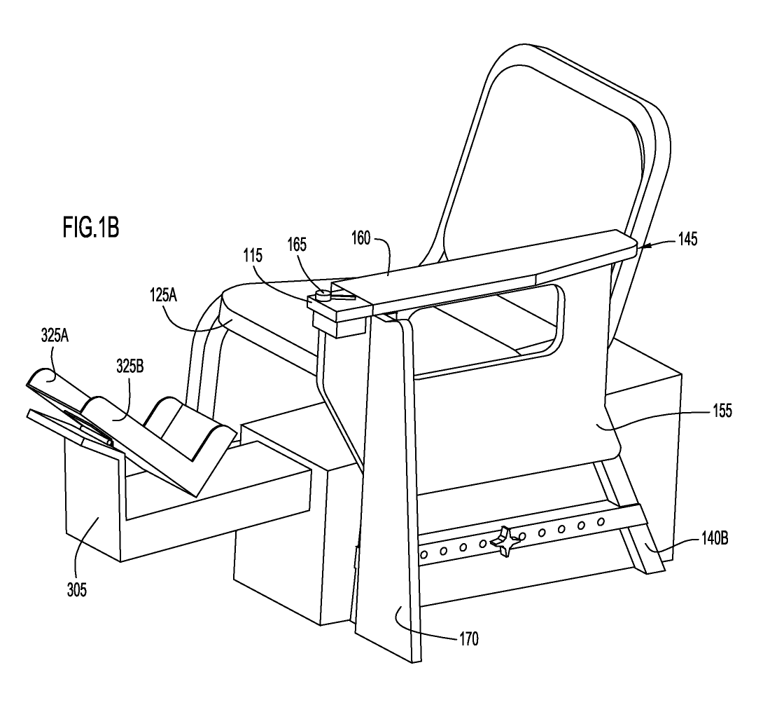

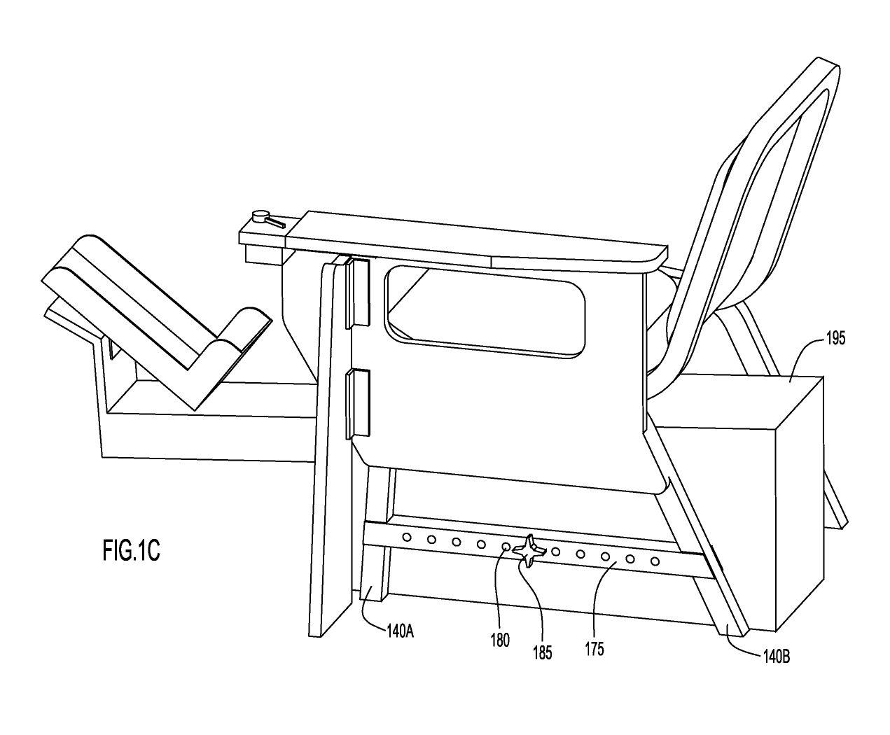

FIGS. 1A-1C illustrate views of a continuous passive motion device (CPM) in accordance with an embodiment of the present invention. The CPM device 10 includes a user support 105, a CPM assembly 110, and a control unit 115. The user support 105 is configured to support a user in a non-supine (e.g., seated position) position, as well as to position the user above the CPM assembly 110. In the embodiment illustrated, the user support 105 includes a chair with a seat portion 120 having forward side 125A, a rearward side 125B, a first lateral side 125C, and a second lateral side 125D that cooperate to define a seating surface 130. The user support 105 may further include a seat back portion 135 oriented generally orthogonal to and positioned above the seating surface 130, proximate the rearward seat side 125B. The seat portion 120 is supported above a supporting surface by one or seat support members 140 extending downward from the seat portion. In the embodiment shown, a pair of forward legs 140A and a pair of rearward legs 140B support the seat 120 above a supporting surface.

The user support 105 further includes a lateral support member 145 disposed along at least one of the lateral sides of the user support 105. Specifically, as seen best in FIG. 1B, the lateral support 145 includes a lower support section 155 and an upper support section or armrest 160. The lower support section 155 may be in form of a generally vertical wall secured to the first lateral side 125C of the seat portion 105 via fasteners (e.g., bolts, screws, etc.). The armrest 160 is a generally horizontal platform disposed along the upper edge of the lower support section 155 and configured to support an arm of a user positioned within the user support 105. The control unit 115 may be disposed at forward position along the upper platform section 160. The control unit 115 may include one or more controller actuators 165 to permit the patient to selectively control the carriage (e.g., to reverse the direction of motor rotation to change the carriage direction), thereby providing the user with the ability to determine the range of the cyclical flexure and extension motion (discussed in greater detail below).

The lateral support member 145 may further include a guard 170 extending transversely from the lower support section 155. The guard 170, substantially aligned with the forward seat edge 125A, provides additional support for the upper platform portion 160 on the supporting surface.

The CPM assembly 110 may be coupled to the user support 105 such that it may be positionally adjusted with respect to the seat portion 120. As best seen in FIG. 1C, the user support 105 further includes a bar 175 extending from the forward leg 140A to the rearward leg 140B along first lateral edge 125C of seat portion 120. The bar 175 includes a plurality of apertures 180 longitudinally spaced along the bar. A fastener 185 including a knob and a threaded male post is selectively inserted into the apertures 180. A female receptacle threaded to complement the threads of the male post of the fastener 185 is formed into the cover 195 of the CPM assembly 110 (female receptacle not illustrated). The female receptacle receives the male post of the fastener 185, releasably securing the CPM assembly 110 to the user support 105.

To adjust the longitudinal position of the CPM assembly 110 along the bar 175 (and thus the forward/rearward position of the CPM assembly with respect to the seat portion 120), the fastener 185 is disengaged from the CPM assembly 110 and from a first aperture of the bar. The CPM assembly 110 may then be repositioned with respect to the user support 105 by moving either the CPM assembly or the user support 105 along the supporting surface. The fastener 185 is then inserted into a second aperture that aligns with the new position of the female receptacle on the CPM assembly 110 to once again secure the user support 105 to the CPM assembly.

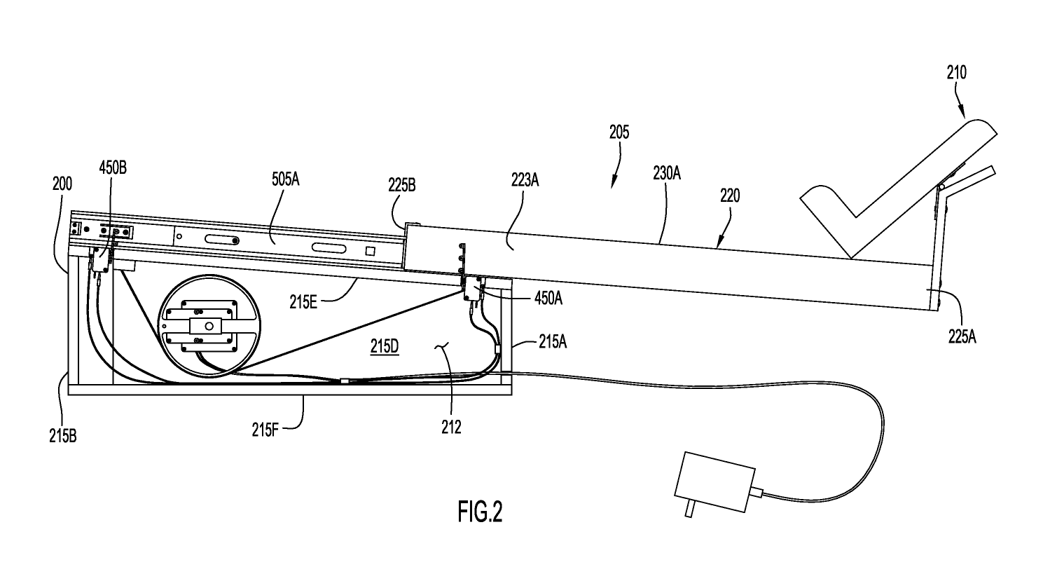

The CPM assembly 110 is configured to continuously drive a leg from a first leg position to a second leg position. The CPM assembly 110 includes a cover 195 that hides the drive components of the device. FIG. 2 shows a perspective view of the drive components of the CPM assembly 110 with the cover 195 removed for clarity. As shown, the CPM assembly 110 includes base or housing 200, a carriage or sliding member 205 movably coupled to the housing, and a foot support assembly 210 coupled to the carriage.

The housing 200 houses the drive assembly of the CPM device 10 within an internal cavity 212 defined by a forward wall 215A, a rearward wall 215B, a first lateral wall 215C, a second lateral wall 215D disposed opposite the first lateral wall, a top wall 215E, and a bottom wall 215F. The housing 200 may be elongated, and include a top wall that is angled in the housing longitudinal direction. Specifically, the height of the housing 200 may gradually decrease in the forward direction (i.e., the top wall 215D declines in the forward direction). In an embodiment, the angle of decline measured from the rear wall 215B to the forward wall 215A is about 5° to about 15° (e.g., about 10°). With this configuration, the carriage 205 projects forward from the housing 200 at an angle in the range of about 5° to about 15°.

The carriage may possess any size and any shape suitable for its intended purpose. In the embodiment illustrated, the carriage 205 comprises a generally inverted-U-shaped structure having a generally planar horizontal portion 220, a first side wall 223A and a second side wall 223B, each side wall being oriented generally orthogonal to the horizontal portion. The carriage 205 defines a forward carriage edge 225A and a rearward carriage edge 225B, as well as an upper, user-facing surface 230A and lower, housing-facing surface 230B. The carriage 205 is arranged to slidably reciprocate longitudinally between extended and retracted positions by means of a slide mechanism (discussed in greater detail below).

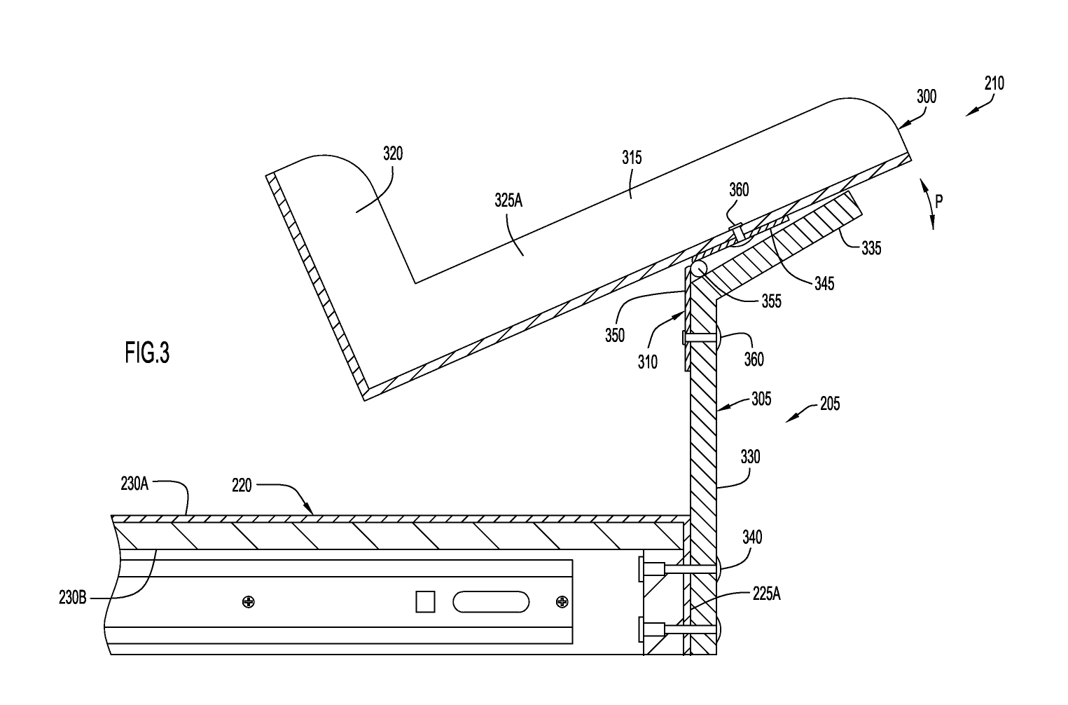

The foot support or pedal assembly 210 is configured to support the foot of a user. The foot support assembly is coupled to the upper carriage surface 230A, being disposed proximate the forward carriage edge 225A. Referring to FIG. 3, the foot support assembly 210 includes a foot support 300 pivotally coupled to a bracket 305 via a hinge member 310. The foot support 300 may generally take the form of a right angle bracket, with a foot pad portion 315 and a heel portion 320 oriented generally orthogonal to the foot pad portion. The foot pad portion 315 receives the sole of the foot, while the heel portion 320 receives the heel of the foot (when the user is seated in the chair). Side walls 325A, 325B extend distally from the transverse edges of the foot pad 315 and heel 320 portions to limit the lateral movement of the foot within the foot support 300, thereby containing the foot of the user within the support.

The bracket 305 may be in the form of a generally L-shaped bracket having a lower bracket portion 330 and an upper bracket portion 335 oriented at an angle with respect to the lower bracket portion 330. By way of example, the upper bracket portion 335 may be oriented at an angle of about 135° with respect to the lower bracket portion 330. The lower bracket portion 330 may be coupled to the forward edge 225A of the carriage 205 via fasteners 340 (e.g., bolts) such that the lower bracket portion is oriented generally orthogonal to the horizontal member 220 of the carriage.

The hinge 310 enables the foot support 300 to be pivotally secured to the carriage 205 to accommodate natural movement of the user's heel during reciprocation of the carriage. In addition, the pivot arrangement may be used to fix the angle of the pedal assembly as determined by a medical professional (e.g., a physical therapist) to provide the desired level of therapy for the patient. The hinge 310 (e.g., a butt hinge), may include a first hinge plate 345 pivotally coupled to a second hinge plate 350 via a pin 355. The first plate 345 is connected to the lower surface of the foot pad 315 along an intermediate location of the pad, while the second plate 350 is connected to the inner surface of the lower bracket portion 330 (e.g., via fasteners 360 such as rivets).

The hinge 310 is secured to the bracket 305 such that the first plate 345 may pivot toward and away from the inner surface of the upper bracket portion 335 (indicated by arrow P). With this configuration, a user may adjust the angular position of the foot support 300 with respect to the bracket 305 (and thus with respect to the carriage 205) from a first foot support position to a second foot support position. By way of example, the foot support 300 may pivot approximately 30°. The ultimate degree of forward pivot is limited by contact between the foot pad portion 305 and the upper bracket portion 335, while the degree of rearward pivot is limited by contact between the heel portion 320 and the carriage 205. In addition, the degree of pivot may be selectively adjustable via a pivot adjustment mechanism that selectively adjusts the degree of pivot. The pivot adjust mechanism may be manual or may be motorized.

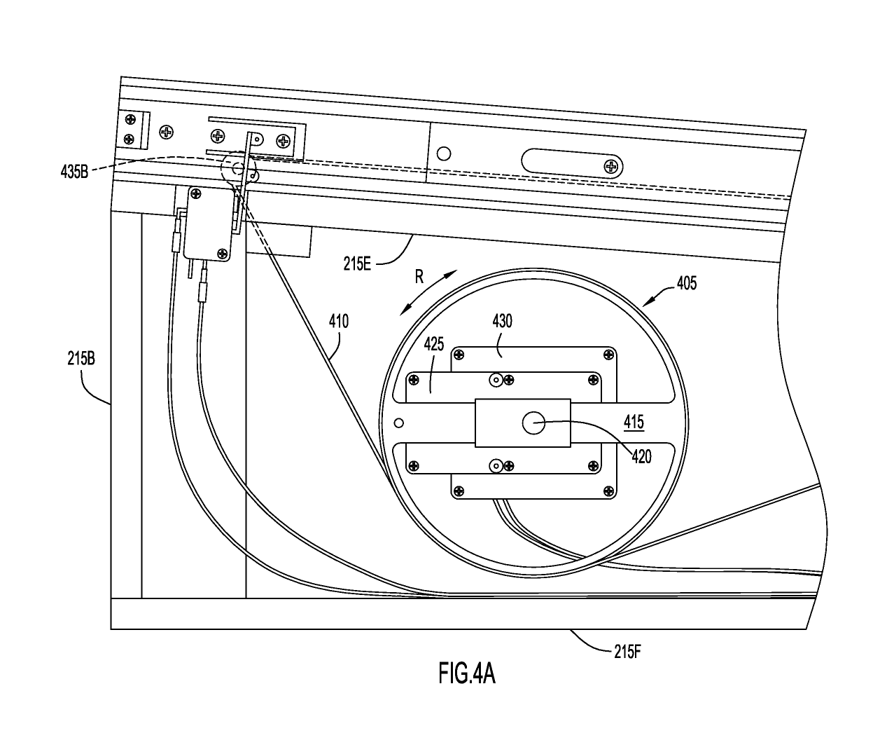

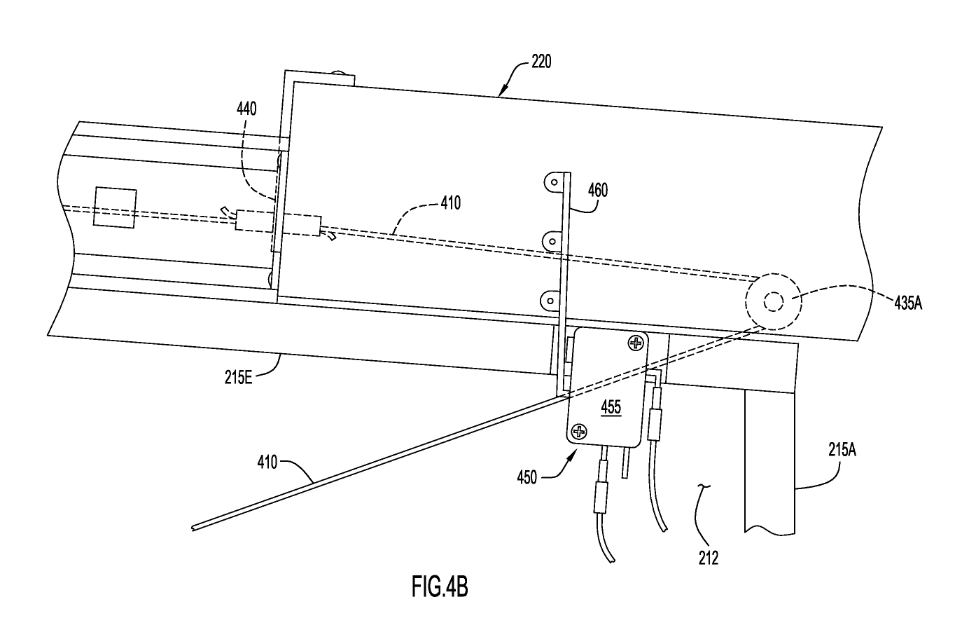

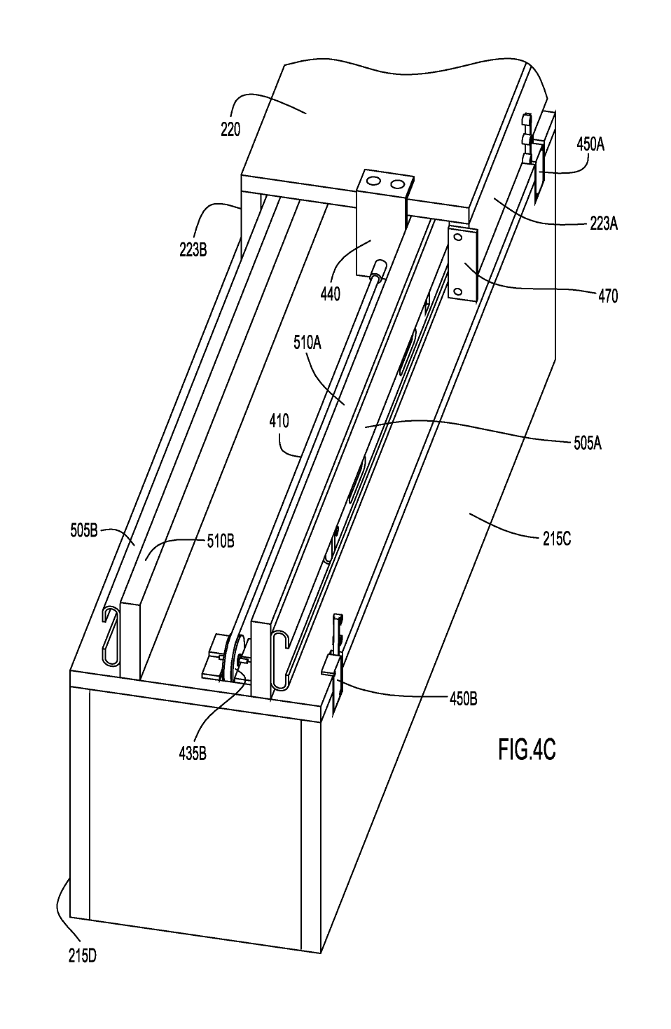

The CPM assembly 110 includes a drive mechanism operable to reciprocally move the carriage 205 along the housing 200 (e.g., to slidably reciprocate the carriage longitudinally between extended and retracted positions). Referring to FIGS. 4A-4C, the drive mechanism includes a drive wheel or drum 405 (e.g., a drum having a diameter of 5.5 inches) that drives a continuous (endless) cable 410 coupled to the carriage 205 (e.g., the cable may be wrapped around the periphery of the drum). The drum 405 may be generally annular, including a bar 415 extending across inner drum diameter. The bar 415 is fixed to a rotating shaft 420 driven by a gear mechanism housed in gearbox 425 that is in communication with a motor housed in motor housing 430 (e.g., a 12 volt reversible DC gear motor). The drum 405 may be rotated in alternate directions by motor 430. Specifically, the drum may be rotated clockwise (forward) and counter-clockwise (rearward) directions by the motor 430 (indicated by R in FIG. 4A).

The cable 410 rides on pulleys mounted along the top wall 215E of the housing 200. Specifically, a first or forward pulley 435A (FIG. 4A) is positioned proximate the forward housing end 215A, and a second or rearward pulley 435B (FIG. 4B) is positioned proximate the rearward housing end 215B. The cable 410 extends from the drum 405, along housing top wall 215E and over the rearward 435A and forward 435A pulleys, and then back to the drum 405. With this configuration, as the drum 405 reciprocates rotationally the carriage reciprocates longitudinally. That is, the clockwise or counter clockwise rotation of the drum 405 generates a corresponding clockwise or counter clockwise rotation of the cable 410 along the pulleys 435A, 435B, which, in turn, generates the longitudinal (e.g., translating or telescoping) motion of the carriage 205.

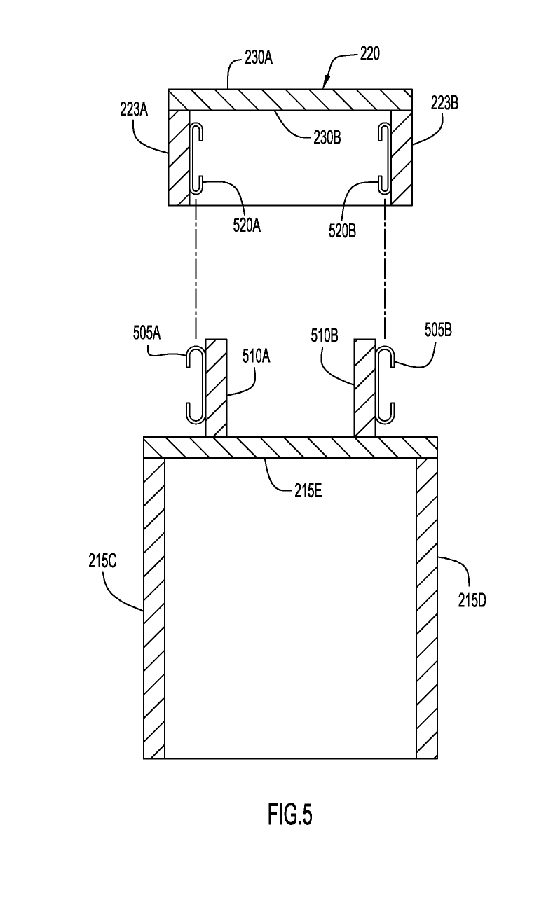

The CPM assembly 110 further includes a slide mechanism that guides the carriage along its travel path. Referring to FIG. 5, the guide mechanism includes a first guide rail member 505A and a second guide rail member 505B each extending longitudinally along the top wall 215E of the housing 200. The first guide rail member 505A is supported by a first rail support 510A disposed proximate first lateral edge 215C of housing, while the second guide rail member 505B is supported by a second rail support 510B disposed proximate the second lateral housing edge 215D.

The carriage 205, moreover, includes complementary guide channels or extension rails that telescopingly mate with the guide rail members 505A, 505B on the housing 200. Specifically a first extension rail 520A, secured to the inner surface of the first carriage side wall 223A, slidingly couples to the first guide rail member 505A. Similarly, a second extension rail 520B, secured to the inner surface of the second carriage side wall 223B, slidingly couples to the second guide rail member 505B. With this configuration, the carriage 205 is configured to slide longitudinally/axially along the housing 200 from a first or retracted carriage position, in which it the carriage is positioned substantially or completely over the housing 200, to a second or extended carriage position, in which the carriage extends distally form the housing, i.e., beyond the forward wall 215A of the housing 200. By way of example, the rail system may include a drawer glide type system (e.g., an Accuride full extension slide, available from Accuride International Inc., Santa Fe Springs, Calif.). As noted above, the cable 410 is coupled to the carriage 205 via a carriage bracket 440 (FIG. 4C). Consequently, rotation of the cable 410 drives the carriage 205 along the guide channel from the first carriage position to the second carriage position.

The degree of extension of the carriage 205 from the housing 200 may be any suitable for its intended purpose. By way of example, in its retracted position, the carriage 205 may be positioned substantially over the housing 200 (e.g., the front edge of the carriage may be flush with or extend slightly beyond the front edge of the housing (e.g., about 2 inches)). In its extended position, the carriage may extend beyond the front edge of the housing approximately 24 inches. Thus, in certain embodiments, the carriage 205 may be configured to possess a travel distance of in the range of about 20 to about 24 inches (e.g., about 22 inches).

Limit switches may be utilized such that they are actuated if the carriage moves beyond predetermined limits to thereby disable the motor and prevent knee flexure or extension beyond safe ranges for the patient. Referring back to FIG. 4B, a limit switch 450 may be a normally closed snap action switch disposed within a housing 455 from which an actuator arm 460 extends to a location to be engaged and actuated by the carriage 205 when the carriage reaches a predetermined position along the rails. As best seen in FIG. 2, a first or forward limit switch 450A is disposed along the first housing lateral side 215C proximate the forward housing wall 215A, and the second or rearward limit switch 450B is disposed along the first lateral side 215C of housing proximate the rearward housing wall 215B. As seen in FIG. 4C the carriage 205 further includes a switch engagement member 470 operable to engage the switches 450A, 450B as the carriage moves with respect to the housing 200. The switch engagement member 470 is a protrusion extending laterally from the first lateral side wall 223A of the carriage 205, disposed along the rearward carriage edge 225B.

With this configuration, should the carriage 205 extend beyond its forward pre-set limit, the switch engagement member 470 will engage the forward limit switch 435A, stopping the motor. Additionally, should the carriage retract beyond its rearward pre-set limit, the switch engagement member 470 will engage the rearward limit switch 435B, stopping the motor. The limit switches 450A, 450B may be repositioned along the housing to alter the pre-set safety limits of the device 10.

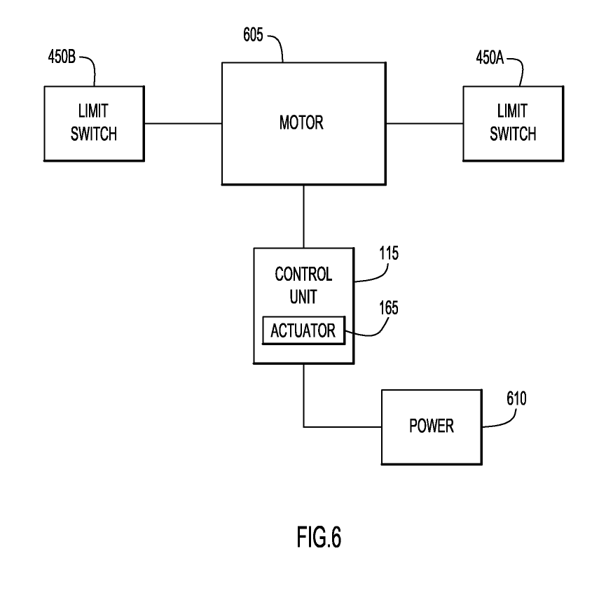

FIG. 6 illustrates an electrical schematic of the components of the drive assembly for the CPM device 10. As shown, the drive device 10 includes the motor 605 (e.g., a reversible 12 V DC motor) in communication with the control unit 115, as well as the forward 450A and rearward 450B limit switches. The CPM device 10 is powered via a power source 610 such as a conventional AC wall outlet (via a conventional step-down transformer). Alternatively, the power source 610 may include a storage pack such as a battery. The actuator 165 on the control unit 115 may be any actuator suitable for its described purpose (to selectively drive the motor in forward and rearward directions). By way of example, the actuator 165 may be a lever-type actuator or may be a pair of momentary pushbutton switches. When the actuator 165 is actuated in its first mode, the DC voltage is applied across motor 605 in a first polarity, causing the motor to rotate in a first direction. When actuator 165 is actuated in its second mode, the polarity of the voltage applied to the motor 605 is reversed, causing the motor to rotate in the opposite direction. In this manner, the patient can alternately actuate the motor 605 to extend and retract the carriage 205 as desired to effect the desired range of knee flexure.

As noted above, the limit switches 450A and 450B are normally closed snap action switches from which an actuator arm 460 extends to a location to be engaged and actuated by switch engagement member 470 on the carriage 205 when the carriage reaches pre-set limits. When either switch 450A or 450B is actuated, it interrupts the 12 volts DC applied to the motor 605, causing rotation to stop. The motor 605 can begin rotating again only in the opposite direction upon actuation of the appropriate actuator mode.

In an alternative embodiment, the control unit may be a digital control unit configured to operate the device 10 under one or more user defined and/or pre-set parameters. For example, the digital control may include a central processor in communication with one or more input buttons used to enter various operational parameters of the treatment session that are then executed by the processor. For example, the user may enter parameters such as the operational range of motion (the extension and flexion angles) the foot support angle, the speed of flexure, etc. Once the information is entered, the device 10 operates automatically to continuously flex and extend the knee. As such, the digital control unit prevents the user from having to personally change the extension and flexion directions of the carriage 205.

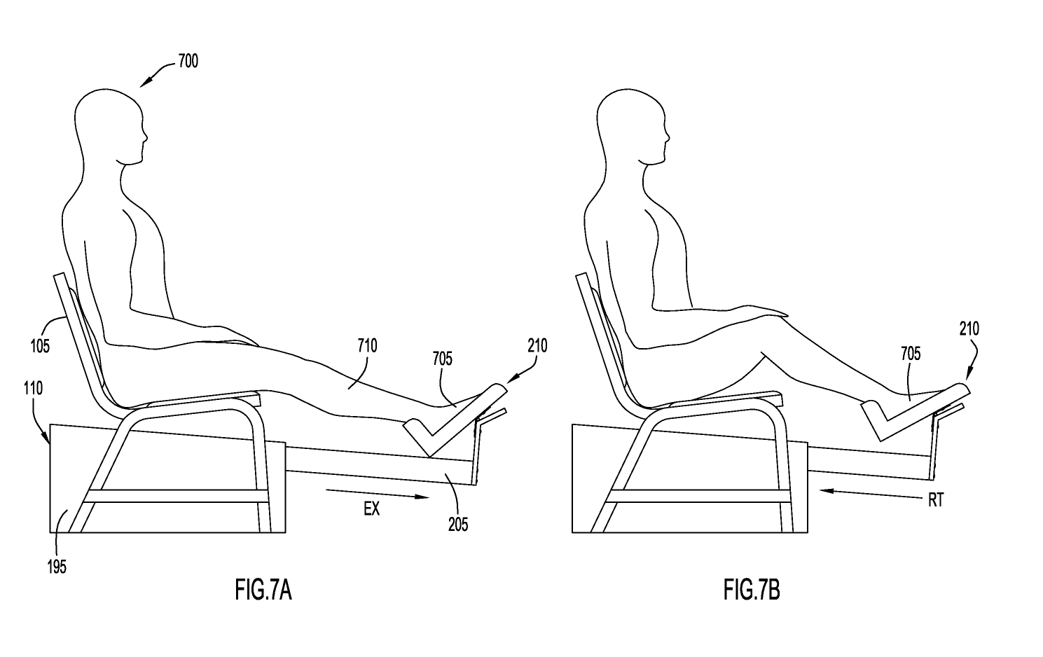

The operation of the device is explained with reference to FIGS. 7A and 7B. As shown, the CPM device 110 is positioned at a predetermined location with respect to the user support 105, i.e., the position of the CPM device 110 may be moved forward or rearward with respect to the seat 120 to adjust for the height of the user, the length of the user's leg, and/or the total available degree of flexure. A user 700 is position within user support 105 such that the user is oriented in a non-supine position (e.g., a seated position). The foot 705 of the user 700 is positioned within the foot support assembly 210, while the leg 710 is oriented generally over the carriage 205. The user then engages the actuator 165 of the control unit 115 (control unit not seen in FIGS. 7A and 7B) to activate the motor, which drives the carriage 205 along the rails such that it extends outward, from its first or retracted carriage position to its second or extended carriage position (indicated by Ex in FIG. 7A). In the extended position, the carriage 205 provides leg extension, extending the leg outward from the user/seat until it reaches a predetermined degree of extension (e.g., a joint angle of about 90°). In the retracted position, the carriage 205 provides leg flexion, bringing the leg inward (toward the user/seat) to bend the joint (knee) of the user until it reaches a predetermined angle of flexion (e.g., a joint angle of up to about 120°).

Once the desired degree of knee extension has been obtained, the user engages the actuator 165 of the control unit 115 to switch the direction of the motor 605 to drive the carriage 205 inward, toward the user from its second/extended carriage position back to its first/retracted carriage position (indicated by Rt in FIG. 7B). In either direction, should the user fail to alter the direction of the carriage 205 such that the carriage extends beyond its forward or rearward pre-set limits, a limit switch 450A, 450B will be engaged, deactivating the motor. This process continues, with the user driving the carriage from its first position to its second position, and vice versa.

Alternatively, when a digital controller is utilized, the user simply activates the power to the device, enters the operational parameters and engages the CPM assembly 110 (e.g., by engaging a START button), causing the extension and flexion as described above.

The above described device provides an open CSM device, i.e., a device that does not require a tibia (upper leg) and/or femur (lower leg) support members for its operation.

While the invention has been described in detail and with reference to specific embodiments thereof, it will be apparent to one skilled in the art that various changes and modifications can be made therein without departing from the spirit and scope thereof. For example, while shown as an open system, the closed system including tibial and/or femoral support members may be utilized. The degree of knee flexion provided by the device is not particularly limited. The device may be formed of any suitable material, including, but not limited to wood, plastic, metal, etc.

Thus, it is intended that the present invention covers the modifications and variations of this invention provided they come within the scope of the appended claims and their equivalents. For example, it is to be understood that terms such as “left”, “right” “top”, “bottom”, “front”, “rear”, “side”, “height”, “length”, “width”, “upper”, “lower”, “interior”, “exterior”, “inner”, “outer” and the like as may be used herein, merely describe points of reference and do not limit the present invention to any particular orientation or configuration.

I claim:

1. A continuous passive motion device for moving an articulate limb through a reciprocal cycle, the device comprising:
a user support operable to support a user in a non-supine position; and
a continuous passive motion assembly coupled to the user support, the assembly comprising:
a housing,
a carriage slidably coupled to the housing, the slidable carriage comprising an elongated platform having proximal and distal ends and a foot support assembly operable to receive and support the foot of a user, and
a drive mechanism disposed within the housing configured to drive the carriage from a first carriage position to a second carriage position.

2. The device of claim 1, wherein the user support comprises a seat and a seat support configured to support the user on a supporting surface such that the user is positioned above the continuous passive motion device.

3. The device of claim 1, wherein:
the drive mechanism comprises a motorized drive wheel that moves a drive cable coupled to the carriage; and
rotation of the drive wheel moves the carriage from the first carriage position to the second carriage position.

4. The device of claim 1, wherein the carriage translates from the first carriage position to the second carriage position.

5. The device of claim 1, wherein the housing comprises an angled top wall.

6. The device of claim 5, wherein the housing comprises:
an elongated housing having sidewalls extending between the angled top wall and a bottom wall, the housing defining a forward housing side and a rearward housing side; and
the angled top wall slopes downward toward the forward housing side.

7. The device of claim 6, wherein:
in the first carriage position, the platform is positioned substantially over the housing; and
in the second carriage position, the platform extends distally from the housing beyond said forward housing side.

8. The device of claim 1 further comprising a first rail coupled to the housing and a second rail coupled to the carriage, wherein said first rail and the second rails are coupled such that the first and second rails telescope.

9. The device of claim 1, wherein a carriage projects forward from the housing at an angle in the range of about 5° to about 15°.

10. The device of claim 1 further comprising a control unit operable to selectively engage the motor to move the carriage from the first carriage position to the second carriage position.

11. The device of claim 1, wherein the control unit comprises a digital control unit including a processor and one or more actuators that permit the user to enter one or more operational parameters of the device.

12. A continuous passive motion device for the flexure of a knee comprising:
a housing;
a slide member coupled to the housing, the slide member being configured to projects distally from the housing at an angle in the range of about 5° to about 15°;
a cable coupled to the slide member;
a motor-operated drum disposed in the housing that drives the cable in forward and rearward directions to longitudinally reciprocate the slide member between extended and retracted positions with respect to the housing; and
actuable switches for selectively changing the direction in which the cable is driven; and
a foot support assembly coupled to the slide member operable to support a foot.

13. The continuous passive motion device of claim 12, wherein the slide member is a translating member that translates with respect to the housing.

14. A method of treating an articulated limb having a joint, the method comprising:
(a) positioning a user within a continuous passive motion device, the continuous passive motion device comprising:
a user support operable to support a user in a non-supine position;
a continuous passive motion assembly coupled to the user support, the assembly comprising:
a housing,
a carriage slidably coupled to the housing, the slidable carriage comprising an elongated platform having proximal and distal ends and a limb support assembly operable to receive and support the limb of a user, and
a drive mechanism disposed within the housing configured to drive the carriage from a first carriage position to a second carriage position, and
a control unit in communication with the drive mechanism; and
(b) selectively engaging a control such that the control unit drives the carriage from the first carriage position to the second carriage position.
